(19) United States
(12) Patent Application Publication
(10) Pub. No.: US 2003/0058413 A1
(43) Pub. Date: Mar. 27, 2003

(54) Visible light modifier and method

(76) Inventor: Jeffrey E. Barnhurst, Henderson, NV (US)

Correspondence Address: WEISS & MOY PC, 4204 NORTH BROWN AVENUE, SCOTTSDALE, AZ, 85251, US

(21) Appl. No.: 09/962,670

(22) Filed: Sep. 26, 2001

(51) Int. Cl. G03B 21/14; G03B 21/00

(52) U.S. Cl. 353/46

(57) ABSTRACT

A visible light modifier and method provide a new visual display. A projection is generated by the visible light modifier that includes a chromatically separated light beam having variations generating a stunning visual display. The display may be used in advertising, entertainment, psychotherapy and anywhere that attention-getting or mood-altering visual displays are desired. The visible light modifier includes a fluid refractive medium bounded by a reflective surface so that an angular chromatic separation is achieved in a beam reflected from the reflective surface through the refractive medium. Motion of the fluid generates variations in the chromatic distribution within of the reflected beam, which can be projected on a screen or other suitable background. Motion of the fluid may be induced externally, for example, by placing the visible light modifier on an audio speaker, or an internal transducer may be included that may be coupled to an audio source or another source of stimulus.

### BACKGROUND OF THE INVENTION

1. Field of the Invention

The present invention relates generally to visible lighting systems, and more specifically, to a projection device for generating visual displays.

2. Background of the Invention

Visible light displays are in use in a multitude of applications. Laser displays are used for entertainment, advertising, education and anywhere that an attention-getting display is desired. In home use, devices such as “Lava Lamps” and small laser or pseudo-laser halogen lamp-based devices provide entertaining displays that may be synchronized to music, enhancing their effect.

Part of the value of the above-mentioned displays lies in the motion of the light, which is generally projected on a screen or other background. The motion of the light provides an effect that may be soothing (slow, curved paths) or stimulating (fast, sharp paths).

As with most entertainment devices, the existing displays mentioned above, now in use for a considerable period or time, have been seen by many people and their “newness” has passed. Also, unless considerable effort is expended in programming a laser or similar visual light display, the variety generated by the display will be exhausted by an audience after a reasonably short period of time.

Therefore, it is always desirable to provide a new visible light display that can capture the attention of an audience. It is further desirable to provide a visible light display capable of variations in the visible light that do not require extensive programming to maintain variety.

### SUMMARY OF THE INVENTION

The above objectives of providing a new visible light display that does not require extensive programming is accomplished by a visible light modifier and method. The visible light modifier includes an illumination lamp, a container partially filled with a fluid refracting medium, and a reflective surface disposed at a lower boundary of the fluid refracting medium. The illumination lamp provides an illumination beam that is refracted by the fluid refracting medium and reflected by the reflective surface such that an angular separation of colors is achieved in a projected beam. Motion of the fluid refracting medium provides a variation in a color distribution at a projection produced by the projected beam.

Lenses may be included to further modify the variations in the projected beam and image masks may be used to provide a background image for the color variations. The fluid may be stimulated by external mechanical means, or the visible light modifier may include a mechanical stimulator. Lenses may be mechanically rotated and translated to produce additional variations creating interesting visual displays.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting a visible light modifier in accordance with a first embodiment of the present invention.

FIG. 2 is a pictorial diagram depicting a visible light modifier in accordance with a second embodiment of the present invention.

FIG. 3 is a pictorial diagram depicting a visible light modifier in accordance with a third embodiment of the present invention.

### DETAILED DESCRIPTION OF THE EMBODIMENTS

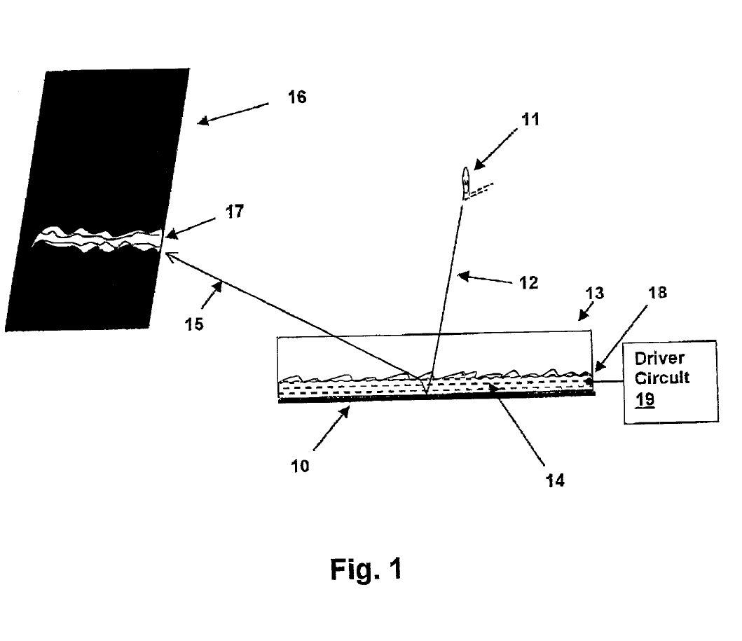

Referring now to the figures and in particular to FIG. 1, a visible light modifier in accordance with a first embodiment of the present invention is shown. An illumination source 11 is used to generate a source of visible light having a broad chromatic spectrum. Sources such as halogen lamps are especially suitable for use in the visible light modifier of the present invention, as the have a high intensity level and a broad spectrum output. Krypton and Xenon lamps are other suitable illumination sources. The sources can be used with or without parabolic reflectors behind them. An illumination beam 12 from illumination source 11 enters the top surface of a container 13 which may have an open top, a transparent top, or a top with sufficient transparent area for the introduction of illumination beam 12.

Illumination beam 12 enters a fluid refractive medium 14 which is disposed within container 13. Fluid refractive medium 14 may be water or another suitable fluid having a refractive index differing from air, or may be a combination of fluids that generate an effect created by local variations of a mixture within container 13. The angle of incidence to produce the effects generated by the present invention should be close to normal to the surface, generally within 5 degrees of normal. A reflective surface 10 is disposed over the bottom surface of container 13 and reflects illumination beam 12 to produce a projected beam 15, which is directed at a projection screen 16 or other suitable background such as a wall, building, billboard, etc.

A projection 17 generated from said projected beam 15 has chromatic characteristics that are created by an angular separation of illumination beam 12 by interaction with fluid refractive medium 14. When fluid refractive medium 14 is motionless, projection 17 will include bands of light of differing color corresponding to the visible spectrum, similar to a rainbow pattern. However, when fluid refractive medium is in motion, projection 17 has a wildly varying color characteristic and shape that provide an entertaining, attention-getting or otherwise mood-altering visual display.

Many optical effects are present within the visible light modifier that generate projection 17 and a complete analysis is not necessary to construct a visible light modifier. Fluid refractive medium 14 and reflective surface 10 refract, diffract (at the surface), multiply-reflect internally and in some cases resonate with a particular color at a particular depth created by the instantaneous shape of the surface of fluid refractive medium 14.

The motion of the surface of fluid refractive medium 14 may be generated in a number of ways. Depicted in the illustration, a transducer 18 may be placed within container 13 so that container 13 or fluid refractive medium can be mechanically disturbed. A driver circuit 19 is coupled to transducer 18 and includes an input that can be coupled to an audio signal, waveform generator, or other suitable source of an electronic signal. Driver circuit may be unnecessary in the case of a transducer 18 coupled to an output of an audio amplifier, and transducer 18 is not required for audio responsive vibration within fluid refractive medium, as container 13 may be placed on or in front of an audio loudspeaker, and the resulting acoustic coupling will generate sufficient motion within fluid refractive medium 14 to vary the characteristics or projection 17. A mechanical system may also be used to mechanically stimulate fluid refractive medium 14, such as a wound spring system, or an oscillatory system.

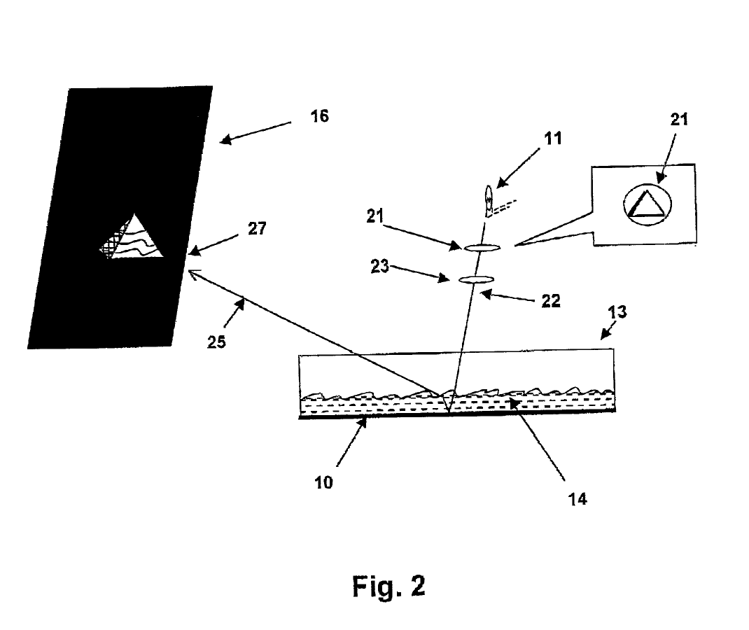

Referring now to FIG. 2 a visible light modifier in accordance with a second embodiment of the present invention is shown. In the second embodiment, an image is generated within a projection 27, by including an image mask 21. Image mask 21 is a convex-convex lens with an imaged etched on a surface of or within the lens, but other masks such as stencil masks or gels may also be used. Illumination beam 22 contains an inverted image corresponding to the pattern etched on or within image mask 21, so a second lens 23 is introduced within the path of illumination beam 22 to rectify the image (second lens 23 could alternatively be introduced in the path of reflected beam 25).

Fluid refractive medium 14 and mirror 10 generate a projected beam 25 similar to that described for the first embodiment, but the image provided by image mask 21 has been introduced with projected beam 25 so that projection 27 is in the shape provided by image mask 21 and having chromatic variations provided by motion of fluid refractive medium 14. A three-dimensional image effect is thereby generated by the visible light modifier, due to the variation of the chromatic distribution over the image. Visible light modifiers in accordance with the second embodiment of the invention are particularly useful in billboard displays or for generating motion-picture effects, as images may be combined with a dazzling chromatic distribution which captures the attention of viewers.

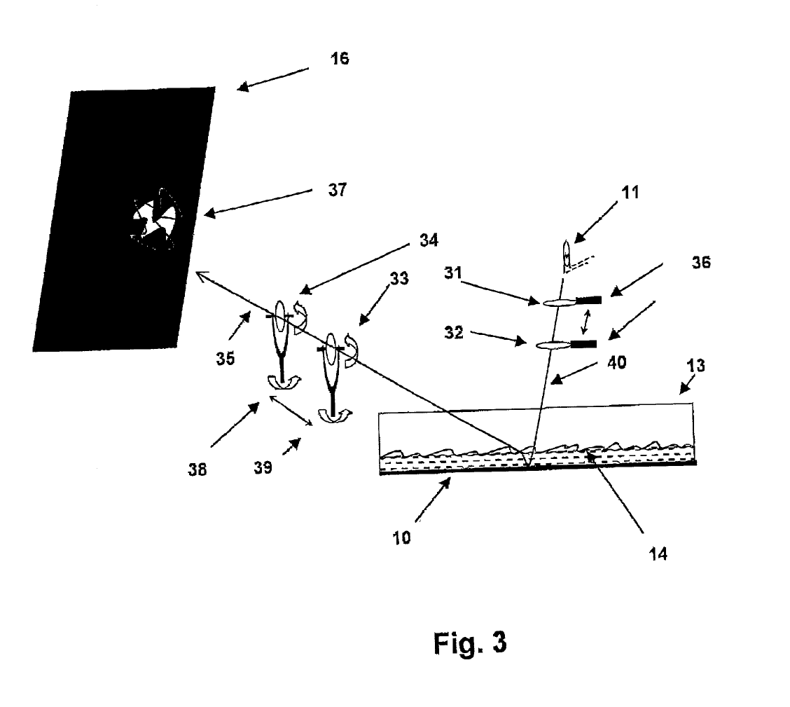

Referring now to FIG. 3, a visible light modifier in accordance with a third embodiment of the invention is depicted. As described for the first and second embodiments, a fluid refractive medium 14 and reflective surface 10 provide a chromatic variation in a projected beam 35 generated by motion of fluid refractive medium 14. In the third embodiment, lenses are introduced within the path of an illumination beam 40, projected beam 35 or both, to provide a variation of a projection 37 produced by projected beam 35. In the path of illumination beam 40, a first lens 31 and a second lens 32 are introduced that concentrate light from illumination source 11. Both lenses are convex-convex in this example, but other combinations may be used. Mount 36 provides for translational motion of lenses 31 and 32, and in practice, lens 31 will generally be fixed in position and lenses 32 will move linearly along the focal axis of lenses 31 and 32 providing adjustment of the beam shape (width). Mount 36 may be manually adjustable, via a crank or other device, or may be electro-mechanically movable similarly to the tranducer induced motion of fluid refractive medium 14 described above for the first embodiment (Transducer induced motion of fluid refractive medium 14 may be used in combination with electromechanical motion of lenses in the third embodiment).

A second pair of lenses 38 and 39 are introduced along the path of projected beam 35. Mounts 38 and 39 for this second pair of lenses are more complex and provide for motion of the lenses both translationally along the focal axis and rotationally at the base of the lens mounts, varying the location of the center of projected beam 35 with respect to lenses 38 and 39, causing projected beam to pass through varying areas of thickness of lenses 38 and 39, moving projection 37 and distorting its shape. Another motional axis of lenses 38 and 39 is in the plane normal to projected beam 35 and follows an elliptical path. The elliptical motion provides a second variation of the centers of lenses 38 and 39 with respect to projected beam 35, altering the resulting projection 37 altering its shape and chromatic distribution. The projection 37 produced by the third embodiment of the invention can be described as a “color plasma” effect and may be projected on a projection screen 16 or is also suitable for use with fog machines or other media having suspended particles, generating a three-dimensional spatial effect where the beam can be seen travelling through a room.

Fog machines or equivalents may be used with any of the above-described embodiments, and in addition to the embodiments mentioned above, other combinations of portions of the above embodiments may be combined. For example, the image mask 21 may be used with the lens systems of the third embodiment, either pair of lenses alone may be used in the third embodiment, and lenses or image masks depicted as located within the projected or illumination beam may be used in the path of the alternative beam. The above variations may produce differing effects or similar effects and are contemplated by the present invention, with the fluid refractive medium and reflective surface being the common elements.

While the artificial illumination sources mentioned above are suitable for use in all of the visible light modifier embodiments, natural light sources may also be used and should be considered as suitable illumination sources.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A visible light modifier, comprising:
an illumination source;
a container;
a reflective surface disposed across a bottom surface of said container, whereby a beam from said illumination source is reflected to produce a projection beam for generating a projection on a background; and
a fluid refracting medium disposed within said container for generating an angular chromatic separation within said projection beam, whereby a motion of said fluid refracting medium generates a variation of a chromatic pattern within said projection.

2. The visible light modifier of claim 1, further comprising:
a transducer mechanically coupled to said fluid refracting medium for generating said motion; and
a driver circuit electrically coupled to said transducer for moving said transducer, whereby said variation of said chromatic pattern is generated in conformity with an input of said driver circuit.

3. The visible light modifier of claim 1, further comprising a mechanical motion generator or generating said motion.

4. The visible light modifier of claim 1, wherein said beam from said illumination device is directed at a top of said container at an axis within 5 degrees of a normal of said reflective surface, whereby a reflected and doubly-refracted beam is emitted through a transparent side of said container for generating said projection.

5. The visible light modifier of claim 1, wherein said illumination source is disposed within said container.

6. The visible light modifier of claim 5, wherein said illumination source is disposed within said fluid refractive medium.

7. The visible light modifier of claim 1, wherein said illumination source is a halogen lamp.

8. The visible light modifier of claim 1, further comprising an image mask disposed between said illumination source and said container within a path of said illumination beam, whereby a background of said projection is generated.

9. The visible light modifier of claim 8, further comprising an image correction lens within a path of said illumination beam for inverting an image of said image mask.

12. The visible light modifier of claim 9, wherein said image correction lens is a convex-convex lens and wherein said image mask is a second convex-convex lens having an image etched on a surface.

13. The visible light modifier of claim 8, further comprising an image correction lens within a path of said projection beam for inverting an image of said image mask.

14. The visible light modifier of claim 1, further comprising a first lens and a second lens disposed along a path of said illumination beam.

15. The visible light modifier of claim 14, further comprising a translation mount mechanically coupled to said second lens for moving a focal point of said second lens along a focal axis of said first lens.

16. The visible light modifier of claim 14, further comprising a third lens and a fourth lens disposed along a path of said projected beam.

17. The visible light modifier of claim 16, further comprising a translation mount mechanically coupled to said third lens for moving a focal point of said third lens along a focal axis of said fourth lens.

18. The visible light modifier of claim 17, further comprising:
a first rotation mount mechanically coupled to said third lens for rotating said third lens along a first axis perpendicular to a focal axis of said third lens; and
a second rotation mount mechanically coupled to said fourth lens for rotating said fourth lens along a second axis perpendicular to a focal axis of said fourth lens.

19. The visible light modifier of claim 18, wherein said first rotation mount further rotates said third lens along a third axis perpendicular to both said focal axis of said third lens and said first axis, and wherein said second rotation mount rotates said fourth lens along a fourth axis perpendicular to both said focal axis of said fourth lens and said second axis.

20. The visible light modifier of claim 19, further comprising:
an elliptical mount mechanically coupled to said third lens for moving said third lens along an elliptical path in a plane perpendicular to said focal axis of said third lens; and
a second elliptical mount mechanically coupled to said fourth lens for moving said fourth lens along an elliptical path in a plane perpendicular to said focal axis of said fourth lens.

21. A visible light modifier, comprising:
an illumination source;
means for generating a continuous variation of a chromatic pattern within a projection of light emitted from said illumination source.

22. The visible light modifier of claim 21, further comprising means for introducing a background within said projection.

23. The visible light modifier of claim 21, further comprising means for altering a shape and chromatic pattern of said projection.

24. A method for generating a visible display, said method comprising:
generating an illumination beam;
directing said illumination through a refractive medium at a reflective surface disposed at a bottom surface of said refractive medium; and
projecting a resulting reflected beam having an angular chromatic separation from said reflective surface on a background to generate a visual display, wherein motion of said refractive medium generates a variation of a chromatic pattern within said projection.

25. The method of claim 24, further comprising introducing an image within said illumination, whereby said projecting projects a projection containing said image.

26. The method of claim 24, further comprising altering a profile of said illumination beam continuously using a lens system with a varying focal distance, whereby said angular chromatic separation is further varied by said altering.

27. The method of claim 24, further comprising altering a profile of said reflected beam using a lens system with a varying focal distance, whereby said projection is further varied by said altering.

28. The method of claim 24, further comprising altering said reflected beam using a lens system by passing said reflected beam through varying thickness of said lens system by rotating said lens system, whereby said projection is further varied by said rotating.

29. The method of claim 24, further comprising altering said reflected beam using a lens system by passing said reflected beam through varying thickness of said lens system by moving said lens system along an elliptical path, whereby said projection is further varied by said moving.
